(19) United States
(12) Patent Application Publication
(10) Pub. No.: US 2008/0167807 A1
(43) Pub. Date: Jul. 10, 2008

(54) Navigation system with immediate language transform and method thereof

(76) Inventors: Jien-Yang Chang, Taoyuan (TW); Shu-Ling Chen, Yilan County (TW)

Correspondence Address: HARNESS, DICKEY & PIERCE, P.L.C., P.O. BOX 8910, RESTON, VA, 20195, US

(21) Appl. No.: 11/650,983

(22) Filed: Jan. 9, 2007

(51) Int. Cl. G06F 17/28; G01C 21/00

(52) U.S. Cl. 701/208; 704/2

(57) ABSTRACT

An immediate language transferring navigating system and the method thereof are provided. The electronic map database includes map information having geographic information, language information and relational information. The language information is expressed in a native language, and the language database includes word databases. The system uses a positioning module to detect the present position and obtains the present map information by an access module, corresponding to the present position. Then a selecting module is used to select a setting word database, which uses a non-native language. Finally, a transferring module is used to transfer the native language of the language information into a selected setting language according to the setting word database, and a display module is used to display the language information in the selected setting language and the corresponding geographic information according to the relational information.

### BACKGROUND

1. Field of Invention

The invention relates to a navigation system and a method thereof, and more particularly, to a navigation system with immediate language transform and the method thereof.

2. Related Art

Originally, a global positioning system (GPS) was a product developed by the U.S. Department of Defense for a satellite defense weapon system for military purposes, providing all weather global navigating route and time information for navigation of a fighter or a lock of a missile. However, when time goes by, the development of the science and the technology and the change of the international political circumstance make people more concerned about the GPS' economic value than its original military purpose. Therefore, engineers started to think about how to commercialize the GPS. For example, combining a GPS with an electronic map can be used for guiding a user in his daily route by providing the speed and direction, the average speed and the highest speed or even by providing tracking and locating functions. Thus, if a user drives with one of the GPS systems, he/she can immediately know where he/she is going without driving and checking the map simultaneously. Therefore, car accidents can be prevented. Further, stopping to ask for help becomes unnecessary.

The GPS uses at least three satellites to determine the location. For example, using four satellites and appropriate geometry calculations, four unknown points including a longitude, a latitude, a height and a calibrating user clock can be determined. Thus, although the offset of the determined position is about 10 to 15 meters, the GPS is precise enough for applying to daily life's guidance.

Using a GPS can help a user quickly find the shortest route to the destination and can provide the overall distance. Moreover, if a GPS is applied to a car, information such as the present driving speed or the emergency alarm can also be provided. Because more and more companies join the GPS market, there are more and more additional functions combined with the GPS in order to attract consumers, such as the information about scenic spots, restaurants and the locations of speed testing cameras, a music video show, a digital photo show, a notebook, and so on for winning the market.

However, an available GPS only shows one language. For example, a GPS bought in Taiwan shows maps only in Chinese. In order to provide the GPS with maps in different languages, the great memory space is necessary for storing all the maps in different languages, which will increase the costs. Besides, even if multiple language maps are included in the GPS, which is sold in for example Taiwan, the economic benefits are low because few people have the chance to use it. Generally, users only search a map or the information of a common region, therefore storing all languages in the system becomes a waste.

### SUMMARY

According to the foregoing problems, an objective of the invention is to provide a navigation system with immediate language transform and method thereof selecting one of the word databases in a language database to undertake the immediate language transformation of the native language of the map.

Therefore, the navigation system with immediate language transform includes an electronic map database, a language database, a positioning module, an access module, a selecting module, a transferring module and a display module.

The electronic map database includes several map information. Each of the map information includes a geographic information, a language information of a native language, and a relational information for relating the language information and the geographic information.

The language database includes several word databases. Every word database has words corresponding to the language information.

The positioning module is used for getting the present position of the user.

The access module is used to obtain a present map information corresponding to the present position of the user from the electronic map database.

The selecting module is used to select a setting word database using a non-native language from the word databases in the language database.

The transferring module is used to transfer the native language of the language information of the present map information into a selected setting language according to the selected setting word database.

The display module is used to display the geographic information of the present map, and to simultaneously display the language information in the selected setting language and the corresponding geographic information.

In addition, a navigation method with immediate language transfer may apply to a navigation system. The method includes the steps of: detecting the present position of the user; obtaining a present map information corresponding to a present position of the user from an electronic map database; selecting a word database using a non-native language from a language database; transferring a native language in a language information of the present map information into a selected setting language according to the selected setting word database; and displaying the present geographic information of the present map information and the corresponding geographic information according to a relation information for relating the geographic information and the language information.

### BRIEF DESCRIPTION OF THE DRAWINGS

The present invention will become more fully understood from the detailed description given below, which is for illustration only and thus is not limitative of the present invention, wherein:

FIG. 1 is a diagram of a navigation system with immediate language transform according to the invention;

FIG. 2 is a flow chart of an immediate language transferring navigation method according to the invention; and

FIG. 3 and FIG. 4 are diagrams showing the specific embodiments of the navigation system with immediate language transform and the method thereof according to the invention.

### DETAILED DESCRIPTION

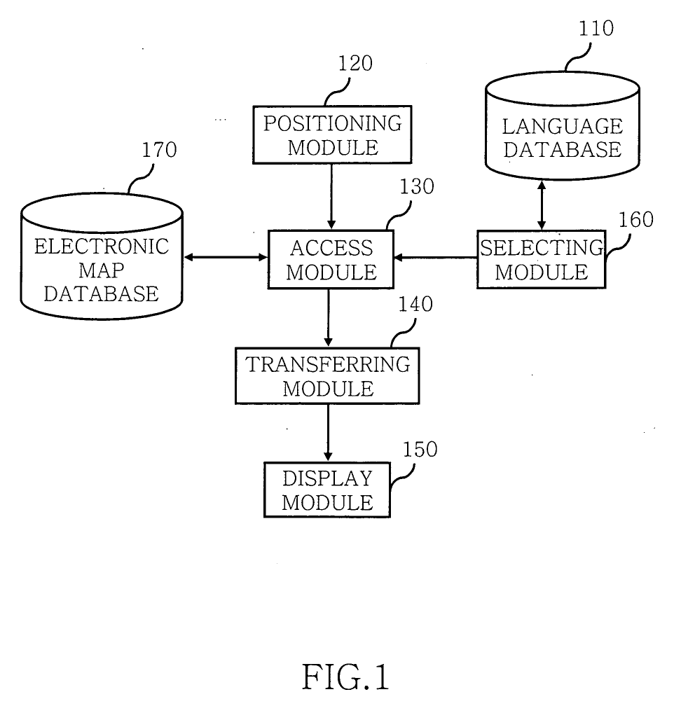

Please refer to FIG. 1 of a diagram of a navigation system with immediate language transform according to an embodiment of the invention. The navigation system with immediate language transform includes an electronic map database 170, a language database 110, a positioning module 120, an access module 130, a selecting module 160, a transferring module 140, and a display module 150.

The electronic map database 170 includes a plurality of map information. The map information includes a geographic information, such as road intersections and locations of roads, a language information, such as names of roads, and an address information. The electronic map database 170 can be a read-only memory (ROM), a hard disc, a memory card or a storage medium, providing the similar function.

The language database 110 includes a plurality of word databases. Every word database has words corresponding to all the language information. For example, if the present map has language information expressed in Chinese [symbol] by using a Chinese database in the language database, the English word database will have the corresponding phases “Minsheng E. Rd.” to prepare for translating the Chinese [symbol] into the English “Minsheng E. Rd.”. The language database 110 can be an erasable programmable read-only memory (EPROM), which can continuously store more different languages when necessary.

The positioning module 120 can be a GPS receiver for receiving satellite signals, to find the present position of the user.

The access module 130 is used for obtaining the present map information from the electronic map database 170. The present map information corresponds to the present position of the user. The access module 130 can be a random-access memory (RAM).

The selecting module 160 is used to select a setting word database from a plurality of word databases in the language database 110. The selecting module 160 can be a remoter, a touch panel, a keyboard, a mouse or other interface with the similar function.

The transferring module 140 is used for transferring the native language in the language information of the present map into the selected setting language according to the setting word database.

The display module 150 is used for displaying the geographic information of the present map, and for displaying the language information in transferred setting language and the corresponding geographic information. The display module 150 can be a liquid crystal display, a cathode ray tube (CRT) or a plasma display.

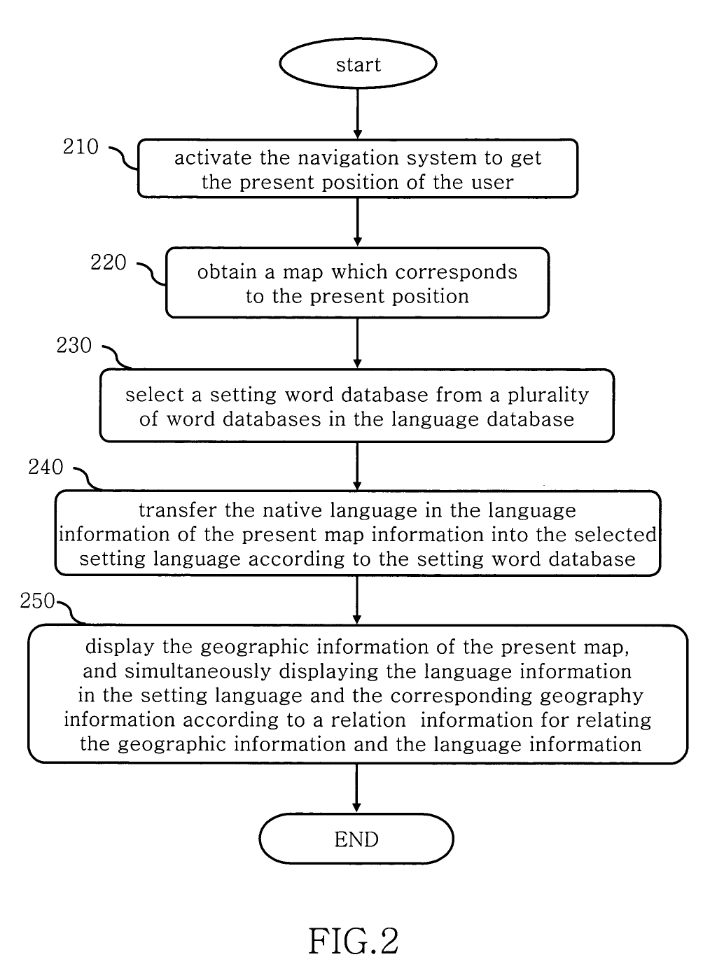

Please refer to FIG. 2 of a flow chart of an immediate language transferring navigation method. The immediate language transforming method may apply to a navigation system, such as a GPS personal digital assistant (PDA). The navigation system includes an electronic map database 170 and a language database 110. The electronic database 170 includes multiple map information. The map information includes a geographic information, a language information and a relation information for relating the geographic information and the language information. The language used in the language information can be considered as a native language. The electronic map database 170 can be a ROM, a hard disc, a memory card, or a storage medium with a similar function. The language database 110 includes a plurality of word databases which correspond to all the language information. The language database 110 can be an EPROM.

First, activate the navigation system to detect the present position of the user (step 210), which can be performed by using a positioning module 120 like a GPS receiver, to receive the satellite signal to find the position of the user.

Next, obtain a map which corresponds to the present position (step 220) and store the map in a RAM.

Then, select a setting word database from a plurality of word databases in the language database 110 (step 230). A user can use a remoter, a touch panel, a keyboard, a mouse or other interface with a similar function to perform this selecting step.

Finally, the system transfers the native language in the language information of the present map into the selected setting language according to the setting word database (step 240), and uses a display to display the present map geographic information and the language information in transferred setting language and the corresponding geographic information. This performance is according to the address information (step 250).

The language information of the present map in the native language also can be displayed by the display.

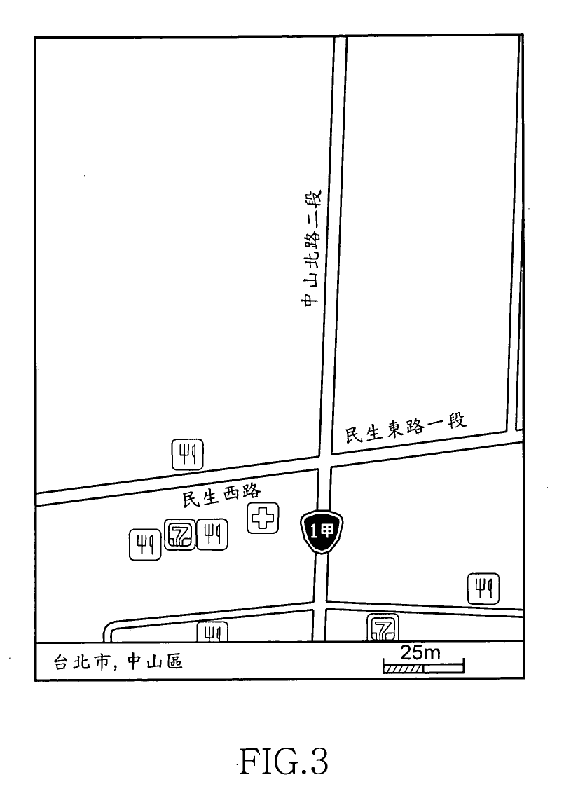

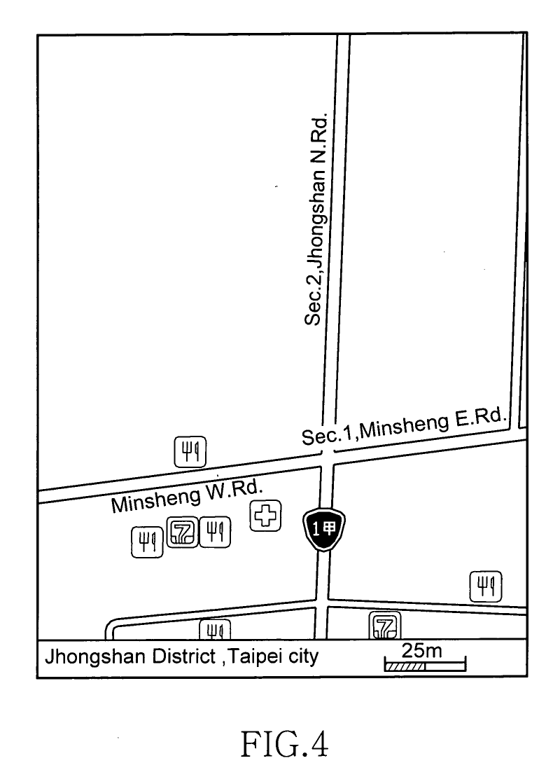

In addition, please refer to FIG. 3 and FIG. 4 of diagrams showing the specific embodiment of the navigation system with immediate language transform and the method thereof. In the present embodiment, the language information of the present map is in Chinese and is stored in the electronic map database, and the language database 110 includes an English word database.

Activate the navigation system and use the positioning module 120 to find the present position of the user. Then obtain the present map information from the electronic map database 170. The present map information corresponds to the present position of the user. As shown in FIG. 3, the language information in the figure is expressed in Chinese.

A user may use a remoter, a touch panel, a keyboard, a mouse or other interface with a similar function to select the English word database from a plurality of word databases in the language database 110. The English word database includes words corresponding to the language information in the map.

Then, the system will translate the Chinese in the map into the corresponding English. For example, the native Chinese characters [symbol] will be translated into the English words “Sec. 2, Jhongshan N. Rd.”; the native Chinese characters [symbol] will be translated into the English words “Sec. 1, Minsheng E. Rd.”; the native Chinese characters [symbol] will be translated into the English words “Minsheng W. Rd.”; and the native Chinese characters [symbol] will be translated into the English words “Jhongshan District, Taipei city”.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A navigation system with immediate language transform, comprising:
an electronic map database having a plurality of map information, each of the map information comprising a geographic information, a language information of a native language, and a relational information for relating the geographic information and the language information;
a language database having a plurality of word databases of languages different from the native language, each of the word database having information corresponding to the language information;
a positioning module for getting a present position;
an access module for obtaining a present map information corresponding to the present position from the electronic map database;
a selecting module for selecting a setting word database using non-native language from the word databases in the language database;
a transferring module for transferring the native language of the language information of the present map information into a selected setting language according to the setting word database, wherein the selected setting language of the language information relates the geographic information by the relational information; and
a display module for displaying the geographic information of the present map, and for simultaneously displaying the language information in the selected setting language and the corresponding geographic information.

2. The navigation system with immediate language transform of claim 1, wherein the positioning module is a GPS receiver.

3. The navigation system with immediate language transform of claim 1, wherein the access module is a RAM.

4. The navigation system with immediate language transform of claim 1, wherein the electronic map database stores in a ROM.

5. The navigation system with immediate language transform of claim 1, wherein the electronic map database stores in a hard disc.

6. The navigation system with immediate language transform of claim 1, wherein the electronic map database stores in a memory card.

7. The navigation system with immediate language transform of claim 1, wherein the language database is an EPROM.

8. An immediate language transforming method for a navigation system, comprising:
detecting a present position;
obtaining a present map information corresponding to the present position from the electronic map database;
selecting a setting word database using non-native language from a language database;
transferring a native language in a language information of the present map information into a selected setting language according to the setting word database, wherein the selected setting language of the language information relates the geographic information by the relational information; and
displaying the geographic information of the present map information, and simultaneously displaying the language information in the setting language and the corresponding geographic information according to a relation information for relating the geographic information and the language information.

9. The method of claim 8, wherein the electronic map database stores in a ROM.

10. The method of claim 8, wherein the electronic map database stores in a hard disc.

11. The method of claim 8, wherein the electronic map database stores in a memory card.

12. The method of claim 8, wherein the language database is an EPROM.

13. The method of claim 8, wherein the step of detecting the present position uses a positioning module.

14. The method of claim 13, wherein the positioning module is a GPS receiver.

15. The method of claim 8, wherein the step of displaying uses a display.

16. The method of claim 8, wherein the present map information stores in a RAM.
